(19) United States
(12) Patent Application Publication
(10) Pub. No.: US 2005/0235971 A1
(43) Pub. Date: Oct. 27, 2005

(54) Method of heating the interior of a vehicle

(76) Inventors: Matthias Klingebiel, Waiblingen (DE); Rudiger Pfaff, Stuttgart (DE); Ulrich Wiebicke, Waiblingen (DE)

Correspondence Address: KLAUS J. BACH, 4407 TWIN OAKS DRIVE, MURRYSVILLE, PA, 15668, US

(21) Appl. No.: 11/159,091

(22) Filed: Jun. 22, 2005

Related U.S. Application Data
(63) Continuation-in-part of application No. PCT/EP03/13068, filed on Nov. 21, 2003.

(30) Foreign Application Priority Data
Dec. 23, 2002 (DE) 102 60 781.8

(51) Int. Cl. F02M 25/07; F02G 5/00

(52) U.S. Cl. 123/568.11; 237/12.3 B

(57) ABSTRACT

In a method of heating the interior of a vehicle having an internal combustion engine with fuel injection and a coolant circuit for transferring waste heat from the internal combustion engine via a heat exchanger to the vehicle interior by increasing the amount of heat transferred to the coolant during low load engine operation by intentional reduction of the engine operating efficiency, the engine is operated with high exhaust gas recirculation rates while transferring heat from the exhaust gas to the coolant for heating the vehicle interior and heating with the relatively large amount of recirculated gas the intake air so that, during the following compression of the intake air and recirculated gas in the engine combustion chamber, the air is heated early to an ignition temperature permitting early combustion of injected fuel so that the fuel injection phase can be extended not only toward late injection but also toward early injection providing for a relative long combustion period whereby engine efficiency is decreased but heat generation is increased.

This is a Continuation-In-Part Application of International Application PCT/EP03/13068 filed 21 Nov. 2003 and claiming the priority of German application 102 60 781.8 filed 23 Dec. 2002.

### BACKGROUND OF THE INVENTION

The invention relates to a method of heating the interior of a vehicle having an internal combustion engine with fuel injection wherein the waste heat transferred from the internal combustion engine to the coolant is supplied via a heat exchanger to the vehicle interior and for increasing the heat transferred to the coolant during low load operation of the internal combustion engine the injector is operated so as to reduce the efficiency of the engine.

DE 196 44 402 C1 discloses a method of heating the interior of a vehicle which includes a diesel internal combustion engine with a heating circuit including a heat exchanger for heating the vehicle interior. The internal combustion engine is operated during low load operation, particularly during engine warm-up with reduced efficiency and increased heat transfer to the coolant in order to increase the heat capacity for heating the vehicle interior. For the reduction of the efficiency, the ignition timing is retarded with respect to the optimal fuel injection timing.

In a motor vehicle with an internal combustion engine having external exhaust gas recirculation and a heating system for the vehicle interior according to WO97/47865, the exhaust gas recirculation is utilized for reducing the temperature as far as the combustion peak temperature is concerned in that in a heat exchanger, heat is removed from the exhaust gas flowing through the exhaust gas recirculation line and used for the heating system of the vehicle. The residual heat of the recirculated exhaust gas consequently should be as small as possible in order to hold the temperature of the intake gas comprising fresh air and the recirculated exhaust gas as low as possible in order to reduce combustion peak temperature since with increasing combustion temperature also the formation of nitrogen oxides is increased.

For charged internal combustion engines with exhaust gas recirculation, it is known from DE 196 18 868 A1 to connect the exhaust gas turbine and the compressor to the exhaust gas side of the engine by way of a heat exchanger in such a way that by means of the fuel exchanger the gas temperature is reduced upstream of the gas turbine and ahead of the compressor the temperature is increased such that the pressure differential required for the exhaust gas circulation is increased and ensured.

Furthermore, from DE 100 29 231 A1, an arrangement and a method for increasing the heating capacity for heating the passenger space of a motor vehicle is known, wherein the internal combustion engine of the vehicle is controlled for an operation at reduced efficiency that is, at increased losses in order to heat the engine more rapidly and, by the increase of waste heat, to more rapidly heat the vehicle interior via corresponding heat transfer devices.

It is the object of the present invention to provide a method of heating a motor vehicle interior wherein the heat transfer to the coolant is further increased so that the heating capacity of the engine coolant is increased.

### SUMMARY OF THE INVENTION

In a method of heating the interior of a vehicle having an internal combustion engine with fuel injection and a coolant circuit for transferring waste heat from the internal combustion engine via a heat exchanger to the vehicle interior by increasing the amount of heat transferred to the coolant during low load engine operation by intentional reduction of the engine operating efficiency, the engine is operated with high exhaust gas recirculation rates while transferring heat from the exhaust gas to the coolant for heating the vehicle interior and heating with the relatively large amount of recirculated gas the intake air so that, during the following compression of the intake air and recirculated gas in the engine combustion chamber, the air is heated early to an ignition temperature permitting early combustion of injected fuel whereby the fuel injection phase can be extended not only toward late injection but also toward early injection providing for a relative long combustion period with a decrease in engine efficiency but an increase in heat generation by the engine.

The increase of the combustion period is also advantageous for the noise behavior of the diesel engine which is particularly critical during engine warm-up so that the solution according to the invention results in an “oven-like” combustion behavior with—in comparison with an efficiency-optimized fuel injection—an intentionally reduced efficiency and therefore improved heating capacity for the vehicle interior, which also acoustically improves the passenger comfort.

In a particular embodiment, the internal combustion engine can be operated in the low load warm-up phase with—in comparison with common exhaust gas recirculation rates of internal combustion engines—very high exhaust recirculation rates which may reach up to 70% and preferably are set up for a range of 50 to 60%.

Furthermore, particularly in connection with a turbocharged diesel engine, an operation has been found to be expedient wherein exhaust gas is branched off the exhaust line ahead of the connection of the exhaust pipe to the exhaust gas turbocharger, so that the exhaust gases have a high temperature level at the heat exchanger. The high thermal energy of the exhaust gases are advantageous for the efficiency and the power output of the turbocharger.

The invention will become more readily apparent from the following description of a particular embodiment thereof on the basis of the accompanying drawings.

### BRIEF DESCRIPTION OF THE DRAWINGS

FIG. 1 shows schematically the arrangement according to the invention, and

FIG. 2 shows two fuel injection characteristics a and b.

### DESCRIPTION OF AN EMBODIMENT OF THE INVENTION

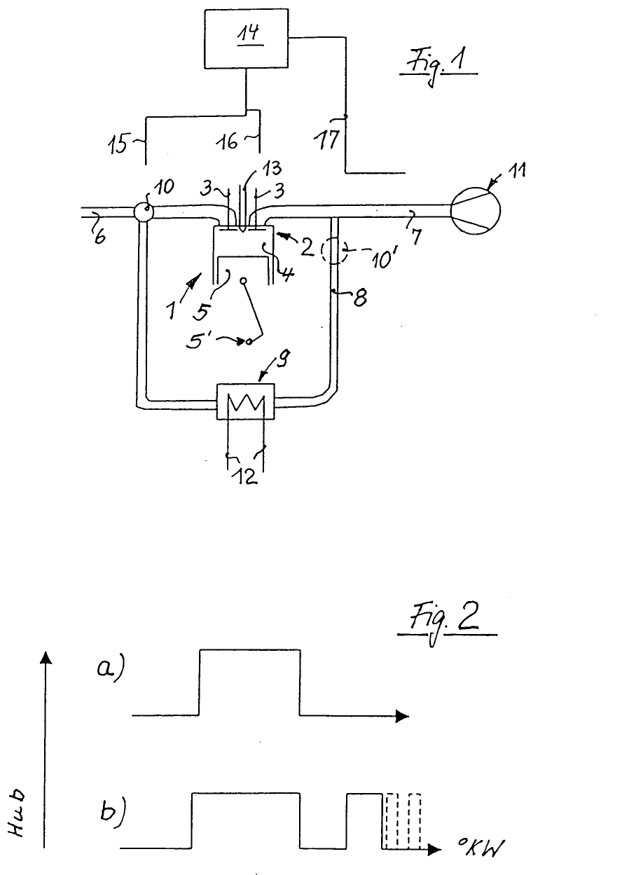

FIG. 1 schematically shows a diesel engine 1 as drive source of a vehicle which is not shown. The diesel engine is indicated by a cylinder 2 with a piston 5 connected to a crankshaft 5′ and delimiting a combustion chamber 4 which is provided with gas change control elements 3 for controlling the gas flows through the engine inlet and outlet passages 6 and 7. The inlet passages 6 and outlet passages 7 are interconnected by an exhaust gas recirculation line 8 for the recirculation of exhaust gases. The exhaust gas recirculation line 8 includes a heat exchanger 9 which is connected to the inlet duct 6 by way of an exhaust gas recirculation valve 10. The valve 10 may be disposed close to the connection to the inlet duct 6 as shown in full lines. With respect to the embodiment, which shows the internal combustion engine in connection with a turbocharger 11 disposed in the exhaust gas duct 7, the exhaust gas recirculation line 8 is connected to the exhaust duct between the turbocharger 11 and the internal combustion engine 1 and the exhaust gas recirculation valve, indicated by 10′ is arranged preferably close to the connection of the exhaust gas recirculation line 8 to the exhaust duct 7.

The internal combustion engine is cooled by a liquid in a conventional way and includes a cooling circuit which is connected to the exhaust gas recirculation line by a heat exchanger 9. The connection to the cooling circuit of the internal combustion engine 1 is indicated by the connecting lines 12. The fuel injection into the combustion chamber 4 of the diesel engine 1 is indicated by an injection nozzle 13. Furthermore, the internal combustion engine 1 is provided with a control unit 14 which, in a well-known manner, depending on a multitude of parameters relevant to the operation of the vehicle and the operation of the internal combustion engine, controls for example the exhaust gas valve 10, the injection nozzle 13 and, if present, the turbocharger 11. The respective control paths are indicated by the lines 15 to 17.

Modern diesel internal combustion engines operate at such a good efficiency that waste heat, particularly during warm-up, but also generally during low load operation, is often insufficient for heating the vehicle interior, particularly for a fast heating thereof, by heat exchange with the cooling circuit of the internal combustion engine, particularly at low ambient temperatures. In accordance with the invention, therefore also the thermal energy contained in the exhaust gas of the internal combustion engine is utilized for heating the vehicle interior and this is done by cooling the exhaust gas recirculated through the exhaust gas recirculation line 8 to the inlet via the heat exchanger 9. The exhaust gas recirculation results in a temperature increase of the engine intake air and consequently also increases the start-out temperature in the combustion chamber 4 for the compression so that, inspite of a reduced filling degree because of the higher temperature of the gas-air mixture entering the combustion chamber the gas compression in the combustion chamber rapidly causes heating of the gas to the ignition temperature so that the fuel injection timing can be advanced. As a result, particularly with a correspondingly timed interrupted injection of the injection volume, the combustion can be extended over a relatively long period which on one hand reduces the efficiency of the internal combustion engine but, on the other hand, increases the heat generated and results in a more rapid and intense heating of the engine cooling circuit and also in higher exhaust gas temperatures. This again is utilized for increasing the heating capacity. The reduced efficiency of the internal combustion engine combustion engine obtained with this procedure has no further disadvantages since, in accordance with the invention, it is used only during low load operation of the engine. The procedure is in fact alleviates a disadvantage of diesel engines, that is, the loud knocking noise during a cold start is reduced since small amounts of fuel are injected over a longer time period.

FIG. 2 shows under a) the stroke of the injection nozzle needle over the crank angle for controlling the fuel injection procedure, with a single main fuel injection volume wherein for an intended reduction of the efficiency the injection period is only extended toward the top dead center position of the crankshaft.

Under b) FIG. 2 shows a solution wherein the fuel is injected in an interrupted timed fashion with timed post injection periods shown by dashed lines. As shown under b) the main injection is also advanced with respect to the Top Dead Center position and there may also be timed interrupted pre-injection as shown by the dashed lines for the timed post injections.

The fuel injection curves according to FIG. 2 represent the possibilities available in connection with the present invention only in an exemplary way. Fast acting fuel injection nozzle provide for various possible additional configurations of the injection pattern.

In connection with the method according to the invention exhaust gas recirculation can be established, in comparison with high power operation of the internal combustion engine, with higher exhaust gas recirculation rates of up to 70%. Ranges of 40-70% particularly of about 50-60% have been found to be very advantageous. Depending on the design of the internal combustion engine, the size of the engine displacement and the respective engine operation method, it may however be advantageous to use lower exhaust gas recirculation rates. The recirculation rates are not dependent on a supercharged engine operation which is very advantageous, since in connection with the present invention engine operation with the higher exhaust gas recirculation rates is established only during low load engine operation where the relatively high thermal energy of the exhaust gases does not result in a thermal overload of the exhaust gas turbocharger because the exhaust gas volume supplied to the turbine is relatively small. On the other hand, the comparatively small exhaust gas volume results in a relatively high turbocharger power output.

This makes it possible to provide for a high turbocharger speed in a relatively low power operating range of the engine. Upon changing over to higher engine power output (torque), noticeably increased engine dynamics are obtained in this way.

1. A method of heating the interior of a vehicle having an internal combustion engine (1) with fuel injection and a cooling circuit including a coolant by which waste heat is transferred from the internal combustion engine (1) via a heat exchanger (9) to the vehicle interior by increasing the heat transferred to the coolant during low load engine operation by intentional reduction of the engine operating efficiency, said method comprising the steps of operating the engine (1) with exhaust gas recirculation while cooling the exhaust gas being recirculated in heat exchange with the coolant, the heat gained thereby being used for heating the vehicle interior and for heating the engine intake air by mixing it with the recirculated exhaust gas and, based on the optimum fuel injection timing for engine power output, obtaining, with the heated intake air during compression an increased temperature of the gas being compressed permitting advanced fuel injection and combustion thereby to extend the combustion period with an advanced fuel injection beginning and a retarded fuel injection end, whereby, while engine efficiency is lowered, engine heat generation is increased.

2. A method according to claim 1, wherein the exhaust gas recirculation is performed with an exhaust gas recirculation rates of 10 to 70%.

3. A method according to claim 2, wherein the exhaust gas recirculation rate is 40 to 70%.

4. A method according to claim 3, wherein the exhaust gas recirculation rate is 50 to 60%.

5. A method according to claim 1, wherein the fuel injector injection occurs in timed intervals.

6. A method according to claim 5, wherein the fuel injection has an injection profile including a main fuel injection with pre-injection and post main injection phases.

7. A method according to claim 5, wherein the fuel injection includes at least one pre-injection phase.

8. A method according to claim 5, wherein the fuel injection includes at least one post injection phase.

9. A method according to claim 6, wherein the main fuel injection is retarded.

10. A method according to claim 9, wherein the whole fuel injection phase is extended with an advanced partial injection phase and a retarded post injection phase.

11. A method according to claim 1, wherein the internal combustion engine (1) is operated with supercharging.

12. A method according to claim 11, wherein the engine is operated with exhaust gas supercharging by a turbocharger (11).

13. A method according to claim 1, wherein exhaust gas for the exhaust gas recirculation is taken from the engine exhaust duct.

14. A method according to claim 12, wherein the exhaust gas for the exhaust gas recirculation is taken from the exhaust duct leading to the turbocharger (11).

15. A method according to claim 2, wherein during low load engine operation, the amount of induced fresh air is minimized by large exhaust gas recirculation rates and the charge pressure is maximized because of a high turbine power output.
